(19) United States
(12) Patent Application Publication
(10) Pub. No.: US 2012/0081329 A1
(43) Pub. Date: Apr. 5, 2012

(54) DIGITAL RESISTIVE TYPE TOUCH PANEL

(75) Inventors: Woon Chun Kim, Gyunggi-do (KR); Yong Soo Oh, Gyunggi-do (KR); Hyun Jun Kim, Gyunggi-do (KR); Jong Young Lee, Gyunggi-do (KR)

(73) Assignee: SAMSUNG ELECTRO-MECHANICS CO., LTD., Gyunggi-do (JP)

(21) Appl. No.: 12/979,959

(22) Filed: Dec. 28, 2010

(30) Foreign Application Priority Data
Oct. 5, 2010 (KR) 1020100097027

(51) Int. Cl. G06F 3/045

(52) U.S. Cl. 345/174

(57) ABSTRACT

Disclosed is a digital resistive type touch panel, including a transparent substrate, a plurality of bar-shaped transparent electrodes mutually formed in parallel in an X-axis direction on the transparent substrate, and electrode wires extending from either or both ends of the bar-shaped transparent electrodes and bundled to one side in a Y-axis direction of the transparent substrate, wherein the bar-shaped transparent electrodes become wider as becoming more distant from one side in the Y-axis direction of the transparent substrate. Thus because the bar-shaped transparent electrodes become wider as the electrode wires get longer, errors can be prevented from occurring when touch coordinates are determined, making it possible for information to be precisely input using the digital resistive type touch panel.

### CROSS REFERENCE TO RELATED APPLICATION

This application claims the benefit of Korean Patent Application No. 10-2010-0097027, filed Oct. 5, 2010, entitled “Digital resistive type touch panel”, which is hereby incorporated by reference in its entirety into this application.

### BACKGROUND OF THE INVENTION

1. Technical Field

The present invention relates to a digital resistive type touch panel.

2. Description of the Related Art

Alongside the growth of computers using digital technology, devices assisting the computers have also been developed, and personal computers, portable transmitters and other personal information processors are used to process text and graphics using a variety of input devices such as keyboards, mouse elements and so on.

The rapid advancement of the information-based society, which is disseminating the use of computers, is being accompanied by the problems of it being difficult to efficiently operate products using only the keyboard and the mouse to perform the functions of an input device. Accordingly, the demand for devices which are simple and infrequently operate erroneously and which enable information to be easily input by anyone, is increasing.

Furthermore, techniques for input devices have surpassed the mere level of fulfilling general functions and have progressed towards techniques related to high reliability, durability, innovation, designing and manufacturing. To this end, touch panels have been developed as an input device capable of inputting information such as text and graphics.

The touch panel is mounted on the display surface of an image display device such as a flat panel display including an electronic organizer, a liquid crystal display (LCD), a plasma display panel (PDP), an electroluminescence (El) element or the like, or a cathode ray tube (CRT), so that a user select the information desired while looking at the image display device.

Also, touch panels are generally classifiable as being of a resistive type, capacitive type, electromagnetic type, SAW (Surface Acoustic Wave) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, the resistive type is widely and prevalently used in different fields. Although a typical resistive type touch panel is problematic because multi touch is impossible, a digital resistive type touch panel in which transparent electrodes are divided was developed.

FIG. 1 is a top plan view showing a conventional digital resistive type touch panel. With reference thereto, the problems of the conventional touch panel are also described below.

As shown in FIG. 1, the conventional digital resistive type touch panel 10 includes a transparent substrate 11, bar-shaped transparent electrodes 12 formed thereon, and electrode wires 13 connected to both ends of the bar-shaped transparent electrodes 12 and bundled to one side 14 of the transparent substrate 11. When a user touches the panel, the digital resistive type touch panel 10 may produce touch coordinates by combining the voltage values at the touch portion. However, the electrode wires 13 get longer as becoming more distant from one side 14 of the transparent substrate 11, resulting in increased resistance. Such a conventional digital resistive type touch panel 10 is problematic in that, even when a user touches the same X-axis coordinates like the first line 15, the X-axis coordinates may be determined in the form of a step shape such as the second line 16 because the electrode wires 13 have different resistances. Hence, errors result when the digital resistive type touch panel 10 determines touch coordinates, making it impossible to precisely input information.

### SUMMARY OF THE INVENTION

Accordingly, the present invention has been made keeping in mind the problems encountered in the related art and the present invention is intended to provide a digital resistive type touch panel, in which the width of bar-shaped transparent electrodes may be increased depending on the length of electrode wires, so that errors may be prevented from occurring when touch coordinates are determined.

An aspect of the present invention provides a digital resistive type touch panel, comprising a transparent substrate, a plurality of bar-shaped transparent electrodes mutually formed in parallel in an X-axis direction on the transparent substrate, and electrode wires extending from either or both ends of the bar-shaped transparent electrodes and bundled to one side in a Y-axis direction of the transparent substrate, wherein the bar-shaped transparent electrodes become wider as becoming more distant from one side in the Y-axis direction of the transparent substrate.

In this aspect, distances between the bar-shaped transparent electrodes which are adjacent to each other may be uniform.

In this aspect, distances between central axes bisecting widths of the bar-shaped transparent electrodes which are adjacent to each other may be uniform.

In this aspect, the bar-shaped transparent electrodes may become wider as the electrode wires extending from the bar-shaped transparent electrodes become longer.

In this aspect, the bar-shaped transparent electrodes may be formed of a conductive polymer.

As such, the conductive polymer may comprise poly-3,4-ethylenedioxythiophene/polystyrenesulfonate (PEDOT/PSS), polyaniline, polyacetylene or polyphenylenevinylene.

Another aspect of the present invention provides a digital resistive type touch panel, comprising a first transparent substrate, a plurality of first bar-shaped transparent electrodes mutually formed in parallel in an X-axis direction on the first transparent substrate, first electrode wires extending from either or both ends of the first bar-shaped transparent electrodes and bundled to one side in a Y-axis direction of the first transparent substrate, a second transparent substrate, a plurality of second bar-shaped transparent electrodes mutually formed in parallel in a Y-axis direction on the second transparent substrate, second electrode wires extending from either or both ends of the second bar-shaped transparent electrodes and bundled to one side in an X-axis direction of the second transparent substrate, and an adhesive layer for adhering an edge of the first transparent substrate to an edge of the second transparent substrate so that the first bar-shaped transparent electrodes and the second bar-shaped transparent electrodes face each other, wherein the first bar-shaped transparent electrodes become wider as becoming more distant from one side in the Y-axis direction of the first transparent substrate, and the second bar-shaped transparent electrodes become wider as becoming more distant from one side in the X-axis direction of the second transparent substrate.

In this aspect, distances between the first bar-shaped transparent electrodes which are adjacent to each other may be uniform, and distances between the second bar-shaped transparent electrodes which are adjacent to each other may be uniform.

In this aspect, distances between central axes bisecting widths of the first bar-shaped transparent electrodes which are adjacent to each other may be uniform, and distances between central axes bisecting widths of the second bar-shaped transparent electrodes which are adjacent to each other may be uniform.

In this aspect, the first bar-shaped transparent electrodes may become wider as the first electrode wires extending from the first bar-shaped transparent electrodes become longer, and the second bar-shaped transparent electrodes may become wider as the second electrode wires extending from the second bar-shaped transparent electrodes become longer.

In this aspect, the first bar-shaped transparent electrodes or the second bar-shaped transparent electrodes may be formed of a conductive polymer.

As such, the conductive polymer may comprise poly-3,4-ethylenedioxythiophene/polystyrenesulfonate (PEDOT/PSS), polyaniline, polyacetylene or polyphenylenevinylene.

### BRIEF DESCRIPTION OF THE DRAWINGS

The features and advantages of the present invention will be more clearly understood from the following detailed description taken in conjunction with the accompanying drawings, in which:

FIG. 1 is a top plan view showing a conventional digital resistive type touch panel;

FIGS. 2 and 3 are top plan views showing a digital resistive type touch panel according to a first embodiment of the present invention;

FIG. 4 is a cross-sectional view showing a digital resistive type touch panel according to a second embodiment of the present invention;

FIG. 5 is a top plan view showing a first transparent substrate, first bar-shaped transparent electrodes and first electrode wires shown in FIG. 4;

FIG. 6 is a top plan view showing a second transparent substrate, second bar-shaped transparent electrodes and second electrode wires shown in FIG. 4;

FIG. 7 is a top plan view showing the modification of the configuration of the first bar-shaped transparent electrodes shown in FIG. 5; and

FIG. 8 is a top plan view showing the modification of the configuration of the second bar-shaped transparent electrodes shown in FIG. 6.

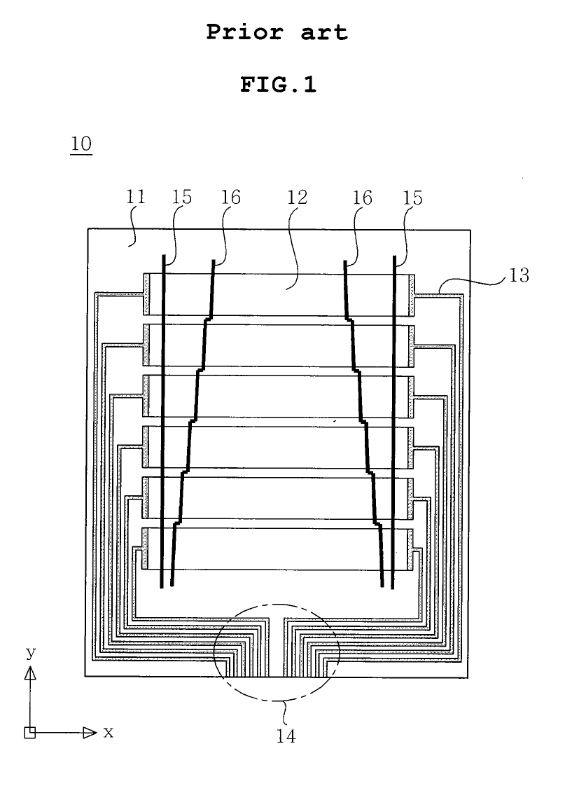

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear. Also, the terms “X-axis direction”, “Y-axis direction”, and “Z-axis direction” are used to depict structural relations between the elements, and the elements are not limited to the above terms.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

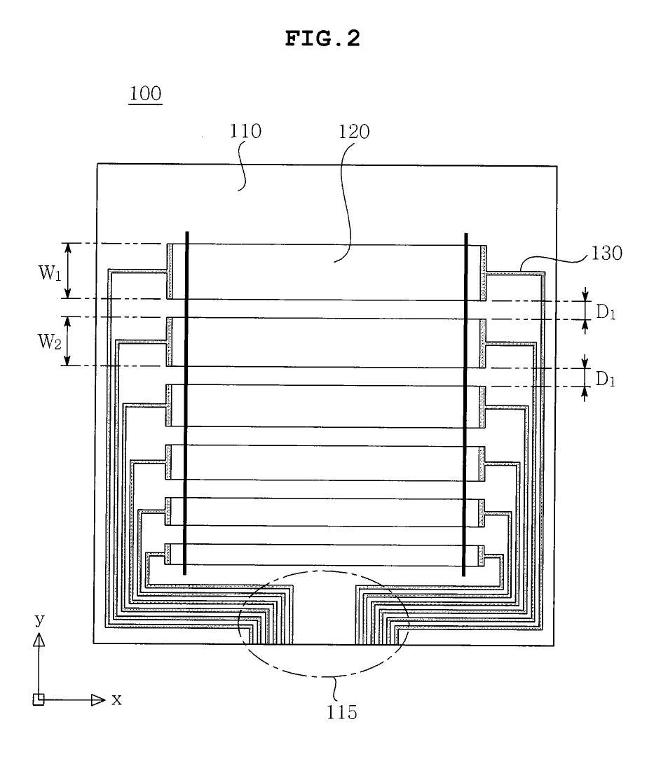

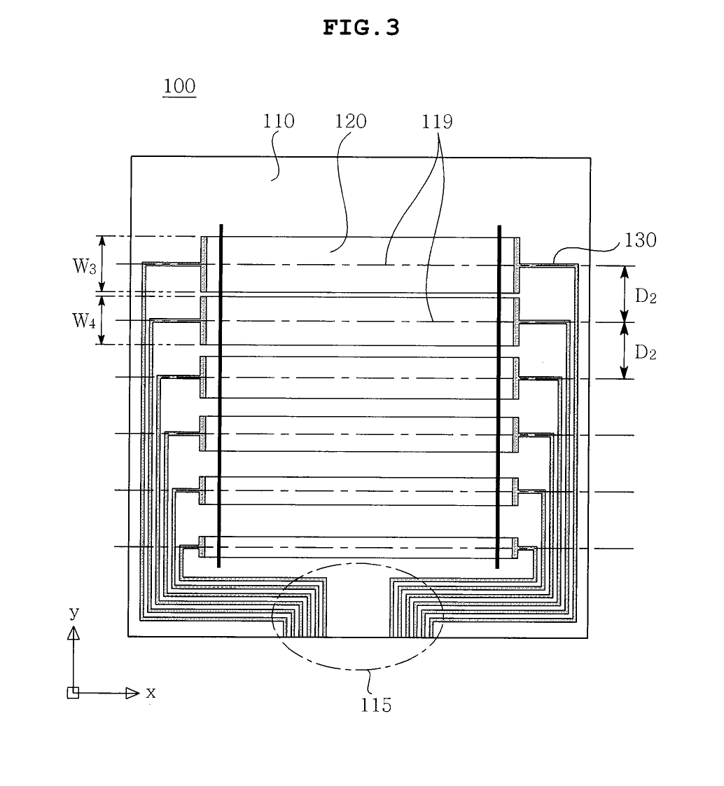

FIGS. 2 and 3 are top plan views showing a digital resistive type touch panel according to a first embodiment of the present invention.

As shown in FIGS. 2 and 3, the digital resistive type touch panel 100 according to the present embodiment includes a transparent substrate 110, a plurality of bar-shaped transparent electrodes 120 mutually formed in parallel in the X-axis direction on the transparent substrate 110, and electrode wires 130 extending from either or both ends of the bar-shaped transparent electrodes 120 and bundled to one side 115 in the Y-axis direction of the transparent substrate 110, in which the bar-shaped transparent electrodes 120 get wider as they become more distant from one side 115 in the Y-axis direction of the transparent substrate 110.

The transparent substrate 110 provides a region where the bar-shaped transparent electrodes 120 and the electrode wires 130 will be formed. As such, the transparent substrate 110 should be imparted with the ability to support the bar-shaped transparent electrodes 120 and the electrode wires 130 and should be transparent so that a user can recognize the image of an image display device. Taking into consideration the supporting ability and the transparency, the transparent substrate 110 may be made of polyethyleneterephthalate (PET), polycarbonate (PC), polymethylmethacrylate (PMMA), polyethylenenaphthalate (PEN), polyethersulfone (PES), cyclic olefin copolymer (COC), TAC (Triacetylcellulose) films, polyvinyl alcohol (PVA) films, polyimide (PI) films, polystyrene (PS), biaxially oriented polystyrene (containing K resin), glass or reinforced glass, but is not necessarily limited thereto. In order to activate the transparent substrate 110, high frequency treatment or primer treatment may be performed. As one surface of the transparent substrate 110 is activated, the force of adhesion between the transparent substrate 110 and the bar-shaped transparent electrodes 120 may be increased.

The bar-shaped transparent electrodes 120 function to enable the voltage values of the touch portion to be recognized by a controller when touched by a user, and are mutually formed in parallel in the X-axis direction on the transparent substrate 110. As such, the bar-shaped transparent electrodes 120 may be made of a typical ITO (Indium Thin Oxide), or a conductive polymer that has high flexibility and is applicable by a simple coating process. An example of the conductive polymer includes poly-3,4-ethylenedioxythiophene/polystyrenesulfonate (PEDOT/PSS), polyaniline, polyacetylene or polyphenylenevinylene. Furthermore, the bar-shaped transparent electrodes 120 may be formed using a dry process such as sputtering or evaporation, a wet process such as dip coating, spin coating, roll coating or spray coating, or a direct patterning process such as screen printing, gravure printing or inkjet printing.

In order to prevent errors from occurring when the touch coordinates are calculated, the plurality of bar-shaped transparent electrodes 120 are formed to be wider as they become more distant from one side 115 in the Y-axis direction of the transparent substrate 110, which will be described later.

The electrode wires 130 function to transfer the voltage values of the bar-shaped transparent electrodes 120 to the controller when touched by a user. The electrode wires 130 may be printed using screen printing, gravure printing or inkjet printing. The electrode wires 130 may be made of a material such as silver (Ag) paste or organic Ag having high electrical conductivity, but is not limited thereto. Alternatively, a conductive polymer, carbon black (including carbon nanotubes), or a metal with a low resistance such as metal oxide such as ITO or metal may be used. Also it goes without saying that the electrode wires 130 in the drawing are connected to both ends of the bar-shaped transparent electrodes 120, which is illustrative, and also may be connected to only one end of the bar-shaped transparent electrodes 120.

The electrode wires 130 may extend from the bar-shaped transparent electrodes 120 and may be bundled to one side 115 in the Y-axis direction of the transparent substrate 110. Thus, the electrode wires 130 may get longer as they become more distant from one side 115 in the Y-axis direction of the transparent substrate 110, resulting in high resistance. In the digital resistive type touch panel 100 according to the present embodiment, the bar-shaped transparent electrodes 120 may get wider as they become more distant from one side 115 in the Y-axis direction of the transparent substrate 110 (W₂→W₁; FIG. 2, W₄→W₃; FIG. 3). Specifically, as the electrode wires 130 extending from the bar-shaped transparent electrodes 120 become longer, the width of each of the bar-shaped transparent electrodes 120 may increase (W₂→W₁, W₄→W₃), and thus the contact areas between the bar-shaped transparent electrodes 120 and the electrode wires 130 may be enlarged, thereby offsetting the increase in resistance of the electrode wires 130. Thus, when a user touches the same X-axis coordinates along the thick line, the digital resistive type touch panel 100 according to the present embodiment may determine the same X-axis coordinates without errors.

Also in order to maintain the sensitivity of the digital resistive type touch panel 100 constant, the bar-shaped transparent electrodes 120 may be configured so that the distances D₁ (FIG. 2) between adjacent two bar-shaped transparent electrodes 120 are made uniform. The configuration of the bar-shaped transparent electrodes 120 is not necessarily limited thereto, or alternatively the bar-shaped transparent electrodes 120 may be configured such that the distances D₂ between central axes 119 (FIG. 3) bisecting the widths of adjacent two bar-shaped transparent electrodes 120 are made uniform.

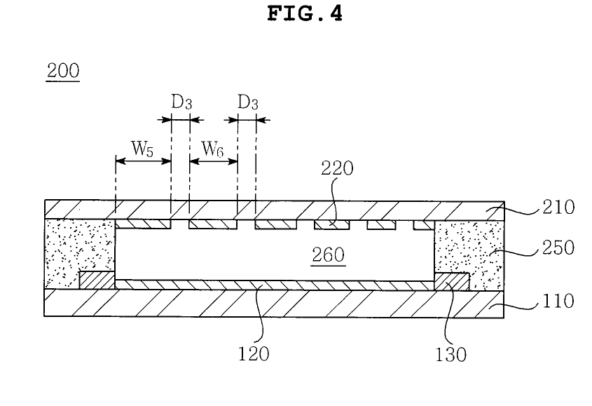

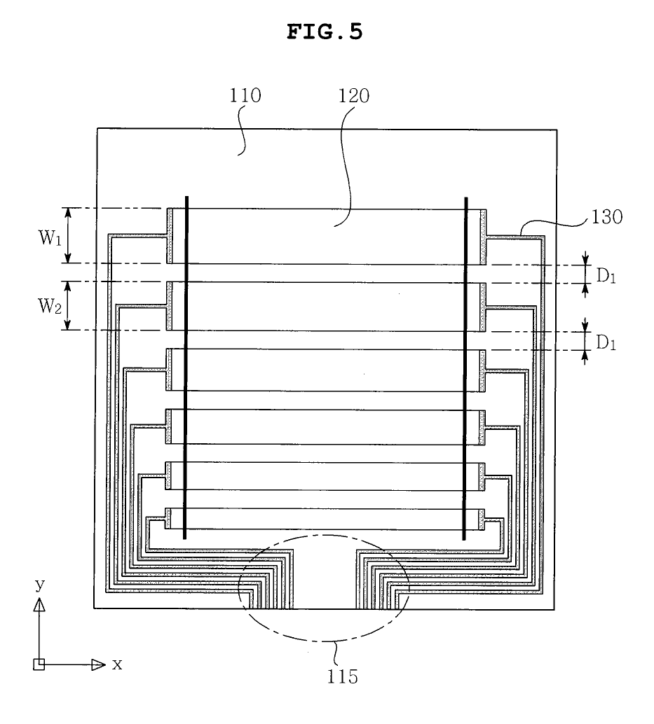

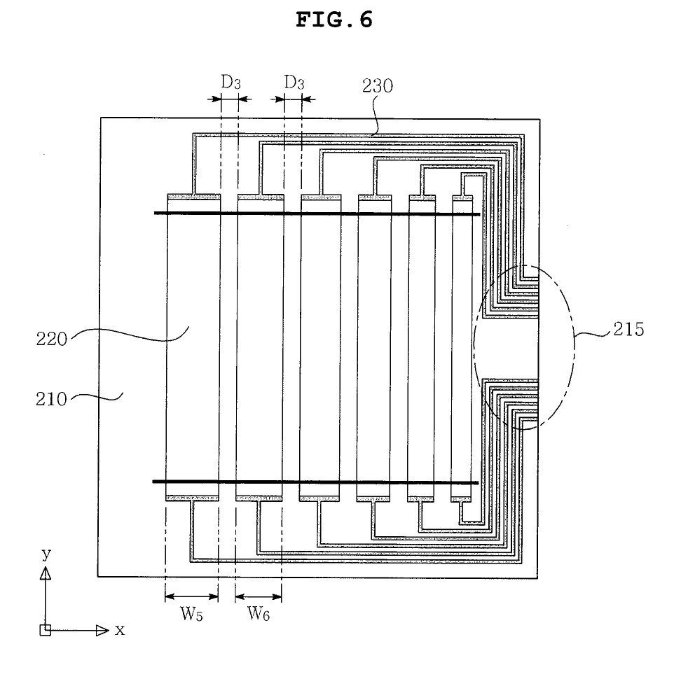

FIG. 4 is a cross-sectional view showing a digital resistive type touch panel according to a second embodiment of the present invention, FIG. 5 is a top plan view showing a first transparent substrate, first bar-shaped transparent electrodes and first electrode wires shown in FIG. 4, and FIG. 6 is a top plan view showing a second transparent substrate, second bar-shaped transparent electrodes and second electrode wires shown in FIG. 4.

As shown in FIGS. 4 to 6, the digital resistive type touch panel 200 according to the present embodiment includes a first transparent substrate 110, a plurality of first bar-shaped transparent electrodes 120 mutually formed in parallel in the X-axis direction on the first transparent substrate 110, first electrode wires 130 extending from either or both ends of the first bar-shaped transparent electrodes 120 and bundled to one side 115 in the Y-axis direction of the first transparent substrate 110, a second transparent substrate 210, a plurality of second bar-shaped transparent electrodes 220 mutually formed in parallel in the Y-axis direction on the second transparent substrate 210, second electrode wires 230 extending from either or both ends of the second bar-shaped transparent electrodes 220 and bundled to one side 215 in the X-axis direction of the second transparent substrate 210, and an adhesive layer 250 which adheres the edge of the first transparent substrate 110 to the edge of the second transparent substrate 210 so that the first bar-shaped transparent electrodes 120 and the second bar-shaped transparent electrodes 220 face each other. As such, the first bar-shaped transparent electrodes 120 may get wider as they become more distant from one side 115 in the Y-axis direction of the first transparent substrate 110, and the second bar-shaped transparent electrodes 220 may get wider as they become more distant from one side 215 in the X-axis direction of the second transparent substrate 210.

The digital resistive type touch panel 200 according to the present embodiment is manufactured in such a manner that that the two-layered bar-shaped transparent electrodes 120, 220 are disposed perpendicular to each other using the digital resistive type touch panel 100 according to the first embodiment. Herein, the description which overlaps that of the first embodiment is omitted, and only additional contents are described.

The first transparent substrate 110 and the second transparent substrate 210 provide regions where the first bar-shaped transparent electrodes 120 and the first electrode wires 130, and the second bar-shaped transparent electrodes 220 and the second electrode wires 230 will be formed. As such, when touched by a user, the second transparent substrate 210 should be flexible so that the second bar-shaped transparent electrodes 220 come into contact with the first bar-shaped transparent electrodes 120 via an air gap 260, and thus it may be made of a material which has comparatively high flexibility. Whereas, the first transparent substrate 110 should provide the supporting ability when the second bar-shaped transparent electrodes 220 come into contact with the first bar-shaped transparent electrodes 120, and thus may be made of a material which has comparatively high rigidness.

The first bar-shaped transparent electrodes 120 are mutually formed in parallel in the X-axis direction on the first transparent substrate 110 (FIG. 5), and the second bar-shaped transparent electrodes 220 are mutually formed in parallel in the Y-axis direction on the second transparent substrate 210 (FIG. 6). Briefly, the first bar-shaped transparent electrodes 120 are disposed perpendicular to the second bar-shaped transparent electrodes 220. Thus, when the top surface of the second transparent substrate 210 is touched by a user, the second bar-shaped transparent electrodes 220 may come into contact with the first bar-shaped transparent electrodes 120, so that the digital resistive type touch panel 200 may combine the voltage values at the touch portion to thus calculate touch coordinates. The first bar-shaped transparent electrodes 120 and the second bar-shaped transparent electrodes 220 may be made of ITO or a conductive polymer such as PEDOT/PSS, polyaniline, polyacetylene, or polyphenylenevinylene.

The plurality of first bar-shaped transparent electrodes 120 may get wider as they become more distant from one side 115 in the Y-axis direction of the first transparent substrate 110, and the plurality of second bar-shaped transparent electrodes 220 may get wider as they become more distant from one side 215 in the X-axis direction of the second transparent substrate 210. The changes in width of the first bar-shaped transparent electrodes 120 and the second bar-shaped transparent electrodes 220 may prevent errors from occurring when calculating the touch coordinates, which will be specified later.

The first electrode wires 130 may extend from either or both ends of the first bar-shaped transparent electrodes 120 and thus may be bundled to one side 115 in the Y-axis direction of the first transparent substrate 110 (FIG. 5), and the second electrode wires 230 may extend from either or both ends of the second bar-shaped transparent electrodes 220 and thus may be bundled to one side 215 in the X-axis direction of the second transparent substrate 210 (FIG. 6). Accordingly, the first electrode wires 130 may get longer as they become more distant from one side 115 in the Y-axis direction of the first transparent substrate 110 to thus increase resistance, and the second electrode wires 230 may get longer as they become more distant from one side 215 in the X-axis direction of the second transparent substrate 210, resulting in high resistance. However, the digital resistive type touch panel 200 according to the present embodiment is configured such that the first bar-shaped transparent electrodes 120 may get wider as they become more distant from one side 115 in the Y-axis direction of the first transparent substrate 110 (W₂→W₁; FIG. 5), and the second bar-shaped transparent electrodes 220 may get wider as they become more distant from one side 215 in the X-axis direction of the second transparent substrate 210 (W₆→W₅; FIG. 6). Specifically, as the electrode wires 130, 230 extending from the bar-shaped transparent electrodes 120, 220 are longer, the bar-shaped transparent electrodes 120, 220, may become wider (W₂→W₁, W₆→W₅), so that the contact areas between the bar-shaped transparent electrodes 120, 220 and the electrode wires 130, 230 may be enlarged, thereby offsetting the increase in resistance of the electrode wires 130, 230. As shown in FIG. 5, when a user touches the same X-axis coordinates along the thick line, the digital resistive type touch panel 200 according to the present embodiment may determine the same X-axis coordinates without errors. Furthermore, as shown in FIG. 6, when a user touches the same Y-axis coordinates along the thick line, the digital resistive type touch panel 200 according to the present embodiment may determine the same Y-axis coordinates without errors.

The adhesive layer 250 (FIG. 4) may adhere the edge of the first transparent substrate 110 to the edge of the second transparent substrate 210 such that the first bar-shaped transparent electrodes 120 are disposed to face the second bar-shaped transparent electrodes 220 with the air gap 260 being interposed between the first and second bar-shaped transparent electrodes. The material of the adhesive layer 250 is not particularly limited but may include double adhesive tape (DAT).

Also in order to maintain the sensitivity of the digital resistive type touch panel 200 constant, the distances D₁ (FIG. 5) between adjacent two first bar-shaped transparent electrodes 120 and the distances D₃ (FIG. 6) between adjacent two second bar-shaped transparent electrodes 220 are made uniform.

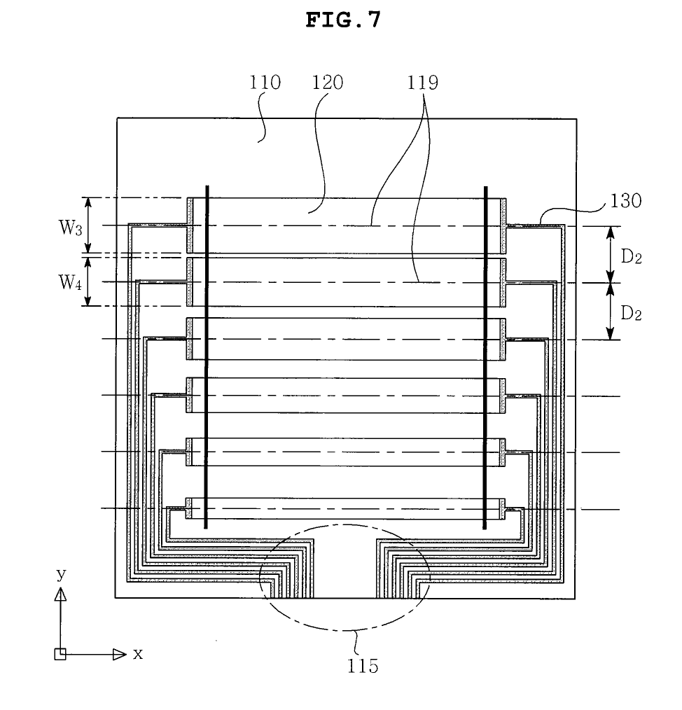

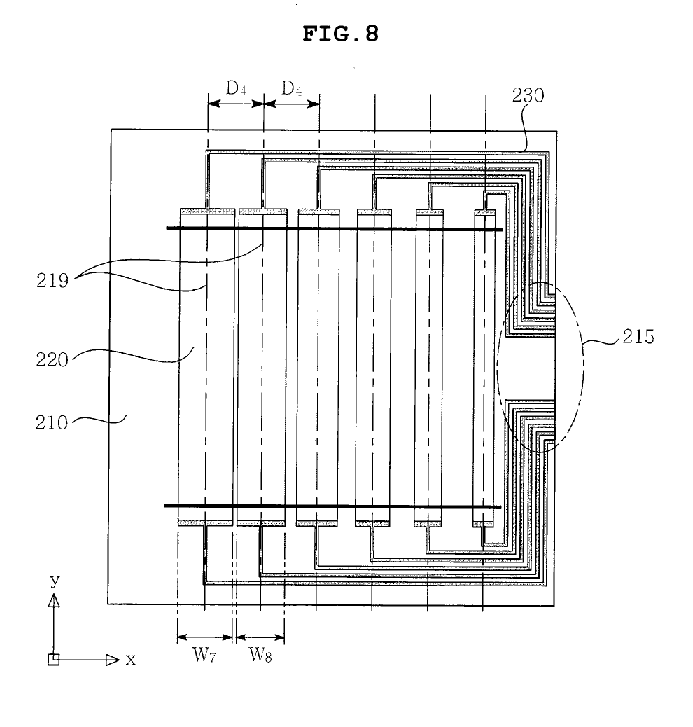

FIG. 7 is a top plan view showing the modification of the configuration of the first bar-shaped transparent electrodes shown in FIG. 5 and FIG. 8 is a top plan view showing the modification of the configuration of the second bar-shaped transparent electrodes shown in FIG. 6.

As shown in FIGS. 7 and 8, the distances between adjacent two first bar-shaped transparent electrodes 120 or the distances between adjacent two second bar-shaped transparent electrodes 220 do not have to necessarily be uniform. Specifically, the first bar-shaped transparent electrodes 120 or the second bar-shaped transparent electrodes 220 may be configured such that the distances D₂ between central axes 119 (FIG. 7) bisecting the widths of adjacent two first bar-shaped transparent electrodes 120 or the distances D₄ between central axes 219 (FIG. 8) bisecting the widths of adjacent two second bar-shaped transparent electrodes 220 are made uniform. In this case, the first bar-shaped transparent electrodes 120 may get wider as they become more distant from one side 115 in the Y-axis direction of the first transparent substrate 110 (W₄→W₃; FIG. 7), and the second bar-shaped transparent electrodes 220 may get wider as they become more distant from one side 215 in the X-axis direction of the second transparent substrate 210 (W₈→W₇; FIG. 8). Accordingly, the digital resistive type touch panel 200 may determine the touch coordinates without errors.

As described hereinbefore, the present invention provides a digital resistive type touch panel. According to the present invention, the width of bar-shaped transparent electrodes is increased depending on the length of electrode wires, and thus errors can be prevented from occurring when determining touch coordinates, thus making it possible for information to be precisely input using the digital resistive type touch panel.

Also, according to the present invention, errors can be prevented from occurring when touch coordinates are determined, without there even being a need for an additional correcting member, thus reducing the manufacturing cost of the digital resistive type touch panel.

Although the embodiments of the present invention regarding the digital resistive type touch panel have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A digital resistive type touch panel, comprising:
a transparent substrate;
a plurality of bar-shaped transparent electrodes mutually formed in parallel in an X-axis direction on the transparent substrate; and
electrode wires extending from either or both ends of the bar-shaped transparent electrodes and bundled to one side in a Y-axis direction of the transparent substrate,
wherein the bar-shaped transparent electrodes become wider as becoming more distant from the one side in the Y-axis direction of the transparent substrate.

2. The digital resistive type touch panel as set forth in claim 1, wherein distances between the bar-shaped transparent electrodes which are adjacent to each other are uniform.

3. The digital resistive type touch panel as set forth in claim 1, wherein distances between central axes bisecting widths of the bar-shaped transparent electrodes which are adjacent to each other are uniform.

4. The digital resistive type touch panel as set forth in claim 1, wherein the bar-shaped transparent electrodes become wider as the electrode wires extending from the bar-shaped transparent electrodes become longer.

5. The digital resistive type touch panel as set forth in claim 1, wherein the bar-shaped transparent electrodes are formed of a conductive polymer.

6. The digital resistive type touch panel as set forth in claim 5, wherein the conductive polymer comprises poly-3,4-ethylenedioxythiophene/polystyrenesulfonate (PEDOT/PSS), polyaniline, polyacetylene or polyphenylenevinylene.

7. A digital resistive type touch panel, comprising:
a first transparent substrate;
a plurality of first bar-shaped transparent electrodes mutually formed in parallel in an X-axis direction on the first transparent substrate;
first electrode wires extending from either or both ends of the first bar-shaped transparent electrodes and bundled to one side in a Y-axis direction of the first transparent substrate;
a second transparent substrate;
a plurality of second bar-shaped transparent electrodes mutually formed in parallel in a Y-axis direction on the second transparent substrate;
second electrode wires extending from either or both ends of the second bar-shaped transparent electrodes and bundled to one side in an X-axis direction of the second transparent substrate; and
an adhesive layer for adhering an edge of the first transparent substrate to an edge of the second transparent substrate so that the first bar-shaped transparent electrodes and the second bar-shaped transparent electrodes face each other,
wherein the first bar-shaped transparent electrodes become wider as becoming more distant from the one side in the Y-axis direction of the first transparent substrate, and the second bar-shaped transparent electrodes become wider as becoming more distant from the one side in the X-axis direction of the second transparent substrate.

8. The digital resistive type touch panel as set forth in claim 7, wherein distances between the first bar-shaped transparent electrodes which are adjacent to each other are uniform, and distances between the second bar-shaped transparent electrodes which are adjacent to each other are uniform.

9. The digital resistive type touch panel as set forth in claim 7, wherein distances between central axes bisecting widths of the first bar-shaped transparent electrodes which are adjacent to each other are uniform, and distances between central axes bisecting widths of the second bar-shaped transparent electrodes which are adjacent to each other are uniform.

10. The digital resistive type touch panel as set forth in claim 7, wherein the first bar-shaped transparent electrodes become wider as the first electrode wires extending from the first bar-shaped transparent electrodes become longer, and the second bar-shaped transparent electrodes become wider as the second electrode wires extending from the second bar-shaped transparent electrodes become longer.

11. The digital resistive type touch panel as set forth in claim 7, wherein the first bar-shaped transparent electrodes or the second bar-shaped transparent electrodes are formed of a conductive polymer.

12. The digital resistive type touch panel as set forth in claim 11, wherein the conductive polymer comprises poly-3,4-ethylenedioxythiophene/polystyrenesulfonate (PEDOT/PSS), polyaniline, polyacetylene or polyphenylenevinylene.
